(19) United States
(12) Patent Application Publication
(10) Pub. No.: US 2009/0279981 A1
(43) Pub. Date: Nov. 12, 2009

(54) METHOD AND APPARATUS FOR MOLDING AN INTERLOCKING CONNECTOR AND CONNECTORS PRODUCED THEREBY

(76) Inventor: Freas C. Kinney, Bishopville, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 12/463,615

(22) Filed: May 11, 2009

Related U.S. Application Data
(60) Provisional application No. 61/127,101, filed on May 9, 2008.

(51) Int. Cl. F16B 21/00

(52) U.S. Cl. 411/340

(57) ABSTRACT

Disclosed is a method and apparatus for molding an interlocking connector, and connectors produced thereby. The connectors comprise a base member having a hollow shaft with a non-circular interior perimeter and at least one undercut provided on a face of the non-circular interior perimeter. Mating anchor members are provided having a support rod configured with a non-circular outer perimeter that may be mated with the non-circular interior of the hollow shaft. The anchor member is provided an end cap which, once installed inside of the hollow shaft, provides a stop surface abutting the undercut so as to prevent lateral separation of the base member and the anchor member. The cooperating, non-circular perimeters of the hollow shaft and the anchor member likewise prevent relative rotation between the two components after they are joined. In a particularly preferred embodiment of the invention, such interlocking connector is used to join the separate components of a multi-part wall anchor system. Likewise, so as to minimize the cost of manufacture of such components, a straight draw molding device is used to form the base member, and particularly to form the undercuts on the interior walls of the hollow shaft of the base member.

### CROSS REFERENCE TO RELATED APPLICATION

This application is based upon and claims benefit of copending U.S. Provisional Patent Application Ser. No. 61/127,101 entitled “Method and Apparatus for Molding an Interlocking Connector and Connectors Produced Thereby”, filed with the U.S. Patent and Trademark Office on May 9, 2008 by the inventor herein, the specification of which is incorporated herein by reference.

### FIELD OF THE INVENTION

The present invention relates generally to methods and systems for molding interlocking members, and more particularly to a straight draw molding assembly and method for producing an interlocking and preferably non-rotational connection having an undercut situated on the interior of a hollow, female member and a mating male member having a feature for engaging the undercut so as to prevent inadvertent separation of the two members after they have been assembled to one another. The invention also relates to connectors formed by the method and apparatus described herein.

### BACKGROUND OF THE INVENTION

Wall anchors have previously been provided to provide a secure receptacle for receiving a screw or bolt, which screw or bolt member can then support a hanging object (such as a mirror, a picture frame, or the like). Such anchors typically comprise a threaded, hollow tube that, prior to installation, is configured for insertion through a small, circular hole in a wall. Once installed, a threaded member is typically threaded into the hollow tube, and as the threaded member is tightened, it pulls the opposite end of the hollow tube towards the inner wall surface, typically expanding a portion of the tube immediately adjacent the interior wall surface, so as to secure the anchor to the wall.

In certain applications, it has been deemed advantageous to provide such anchors as multi-part anchoring systems to improve the distribution of forces on the anchor when placed in service. For instance, in both U.S. Pat. Nos. 5,944,466 and 6,007,285, the specifications of which are incorporated herein by reference in their entireties, cantilever fastener assemblies are provided comprising an apertured face plate and a separate anchoring assembly configured to receive a positioner which pulls the anchoring assembly against the interior surface of a wall in which the fastener is installed. Unfortunately, as such constructions require insertion of such a positioner, and in turn engaging the positioner with a threaded distal end of the anchoring assembly, there is a tendency for the positioner itself to push the anchoring assembly away from the wall when the positioner starts to engage the threaded opening. If the user continues pushing the positioner into the wall without properly engaging the anchoring assembly, the anchoring assembly will fall off of the face plate member and will be lost behind the wall. Moreover, even if a user is successful in engaging the positioner with the anchoring assembly, once the two are engaged, they will tend to rotate together, thus making it difficult to properly anchor the anchoring assembly against the interior surface of the wall. It would therefore be advantageous to provide a multi-part anchoring system that eased installation, and in particular that prevented both inadvertent lateral separation of the anchoring member from the face plate member, and rotation of the anchoring member with respect to the face plate member during installation.

Moreover, in order to be commercially viable, such wall anchor assemblies must be inexpensive for the end consumer and, in turn, inexpensive to manufacture. Straight draw injection molding processes have been previously used to inexpensively cast tubular elements. However, difficulty exists in straight draw molding an elongate, generally tubular element with internal features that could be used as stops, detents, or the like to prevent lateral movement between such tubular element and an insert for that element. It would therefore be desirable to provide a straight draw injection mold and straight draw injection molding process capable of forming an elongate, tubular element, such as a face plate member for a wall anchor, including an internal stop, detent, or similar feature to prevent lateral movement of a corresponding anchor member during the installation or assembly process.

### SUMMARY OF THE INVENTION

Disclosed is an interlocking connector configured to prevent rotation and lateral displacement of an anchor member and a base member in a multi-part assembly, and particularly in a multi-part wall anchor system. An anchor member has a plurality of arms and a non-circular support rod configured to mate with the non-circular interior of a hollow shaft on a base member. The mating of such non-circular members prevents their rotation with respect to one another when engaged. Further, the hollow shaft on the base member is provided at least one undercut on an interior face of the hollow shaft, which undercut engages the support rod on the anchor member so as to prevent lateral separation of the anchor member from the base member after they have been engaged. One particularly preferred apparatus incorporating such interlocking connector is a multi-part wall anchor system, in which a base member is configured for insertion into a wall section, while an anchor member is configured for insertion through such wall section and for clamping against an interior surface of such wall section. During installation, the non-circular configuration of the hollow shaft on the base member and of the support rod of the anchor member prevent relative rotation between the two, such that a connector (such as a screw or bolt) configured to pull the anchor member toward the base member can easily be installed without the anchor member rotating freely with respect to the base member. Likewise, the undercut or undercuts provided on the interior of the hollow shaft of the base member prevents inadvertent separation of the anchor member from the base member after insertion into the wall section.

Also disclosed is a straight-draw molding apparatus and method for forming the interlocking connector described above.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows side and cross-sectional views of an anchor member for use in an interlocking connector incorporating certain aspects of a first particularly preferred embodiment of the invention.

FIG. 2 is a side view of a base member for use in an interlocking connector incorporating certain aspects of a first particularly preferred embodiment of the invention.

FIG. 3 is a top-down view of the base member of FIG. 2.

FIG. 4 is a cross-sectional view of a straight draw molding apparatus in accordance with another aspect of a particularly preferred embodiment of the invention.

FIG. 5 is a bottom-up, cross-sectional view of the apparatus of FIG. 4 along section line B-B.

FIG. 6 is a top-down, cross-sectional view of the apparatus of FIG. 4 along section line C-C.

### DETAILED DESCRIPTION OF THE INVENTION

The invention may be better understood by referring to the following description, which should be read in conjunction with the accompanying drawings in which like reference symbols are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

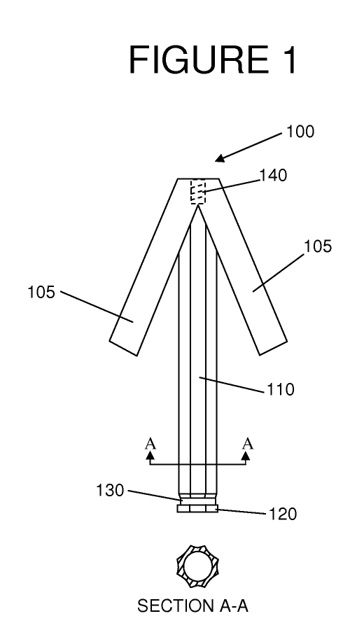

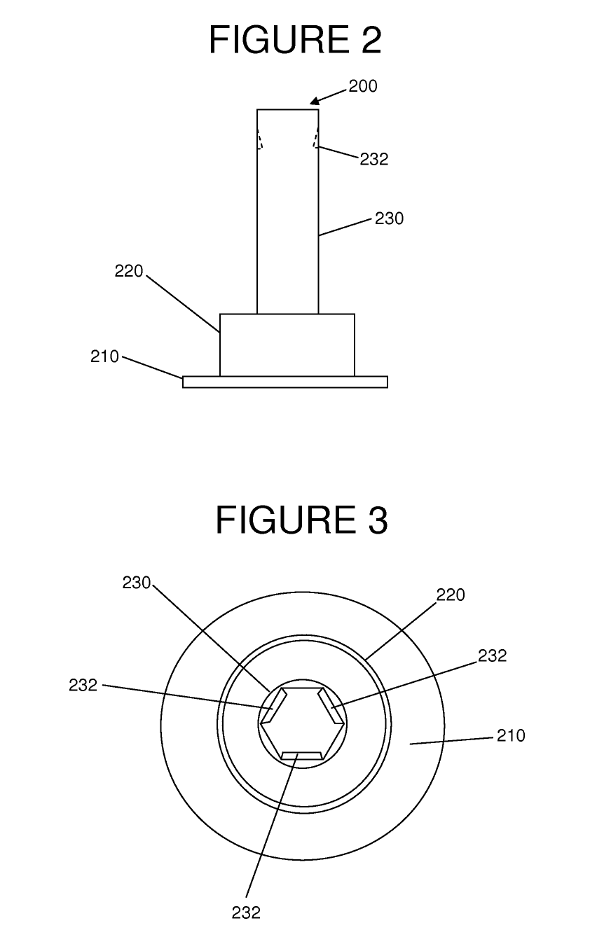

In accordance with a first aspect of a particularly preferred embodiment of the invention, an exemplary wall anchor comprises an anchor member 100 (FIG. 1) and a base member 200 (FIGS. 2-3). Anchor member 100 may have one or more arms 105 and a support rod 110. Support rod 110 may preferably have a generally hexagonal form, although other preferably non-circular configurations could likewise be used. As discussed in greater depth below, a non-circular configuration for support rod 110 may be provided to prevent respective rotation between support rod 110 and base member 200 when the anchor is being installed into a wall surface. Optionally, and as shown in the sectional view portion of FIG. 1, at least portions of the exterior walls of support rod 110 may be slightly concave throughout much of the length of support rod 110. At the bottom of support rod 110 is a cap member 120. The exterior walls of cap member 120 are preferably planar, and thus not provided the optionally concave configuration of the exterior walls of support rod 110. Between support rod 110 and cap member 120 is a region of reduced outer diameter 130. The intersection of region 130 with cap member 120 forms a stop against an undercut formed on the interior of base member 200 (as discussed in greater detail below), which in turn prevents separation of anchor member 100 from base member 200 during installation of the anchor.

As shown in the side view of FIG. 2 and the top down view of FIG. 3, base member 200 includes a base plate 210, a support ring 220 extending upward from base plate 210, and hollow shaft 230. As best seen in the top down view of FIG. 3, the interior walls of shaft 230 are not cylindrical, but rather form a preferably hexagonal opening configured to receive support rod 110. The interior walls of shaft 230 are preferably planar, such that the points of contact between support rod 110 and hollow shaft 230 for much of the length of support rod 110 are minimized to the vertices of the hexagonal walls of support rod 110, in turn reducing the amount of frictional resistance against movement of support rod 110 within hollow shaft 230.

As shown in FIGS. 2 and 3, an undercut 232 is provided on the interior of hollow shaft 230, positioned generally near the end of hollow shaft 230 opposite base plate 210. The undercut is preferably formed as a ridge on less than all of the interior walls of hollow shaft 230. It has been found to be of particular preference to provide three such ridges on the interior of hollow shaft 230 when the interior is formed in the shape of a hexagon. When support rod 110 of anchor member 100 is inserted into hollow shaft 230 and cap member 120 is forced past undercut 232, support rod 110 may thereafter slide within hollow shaft 230 with relative ease. If, however, anchor member 100 is pulled in a direction so as to separate it from base member 200, the stop formed by cap member 120 will ultimately contact undercut 232, preventing further movement of anchor member 100 away from base member 200 without the application of excessive force. Thus, after the anchor has been inserted into a wall and the user no longer has access to anchor member 100, inadvertent separation of the two components is avoided.

As shown in FIGS. 1-3, both anchor member 100 and base member 200 are preferably hollow. Likewise, the end of anchor member 100 is provided an internal, threaded connecting member 140. Thus, once the combined assembly of anchor member 100 and base member 200 is inserted into a wall, a threaded connector, such as a screw or bolt, may be inserted through base plate 210 of base member 200, extend through both hollow shaft 230 and support rod 110, and engage threaded connecting member 140. Tightening of such threaded connector will in turn draw anchor member 100 towards base member 200, causing wings 105 to come into contact with the back side of a wall surface to which the anchor is being attached, thus locking the anchor in place. The non-circular, and preferably hexagonal configuration of support rod 110 and hollow shaft 230 are suitable to prevent rotation between anchor member 100 and base member 200 as the anchor is being locked in position (i.e., as the threaded member is tightened). Likewise, inadvertent separation of anchor member 100 from base member 200 during insertion of the threaded member or otherwise is avoided as a result of undercut 232 engaging the stop formed by cap member 120 of anchor 100.

Such wall anchor configuration thus simultaneously prevents the relative rotation of the two members and inadvertent lateral separation of the two members of the anchor. Persons of ordinary skill in the art will recognize that such anti-rotational and interlocking features will have application outside of wall anchors, and can in fact be applied to any assembly for which such an interlock is desirable. For instance, such an interlock could be used to attach plastic containers having one or more downwardly extending support rods configured similarly to support rod 110 to plastic pallets having one or more upwardly extending hollow shafts configured similarly to hollow shaft 230, thus preventing inadvertent rotation and/or separation of the container from such pallet during shipment.

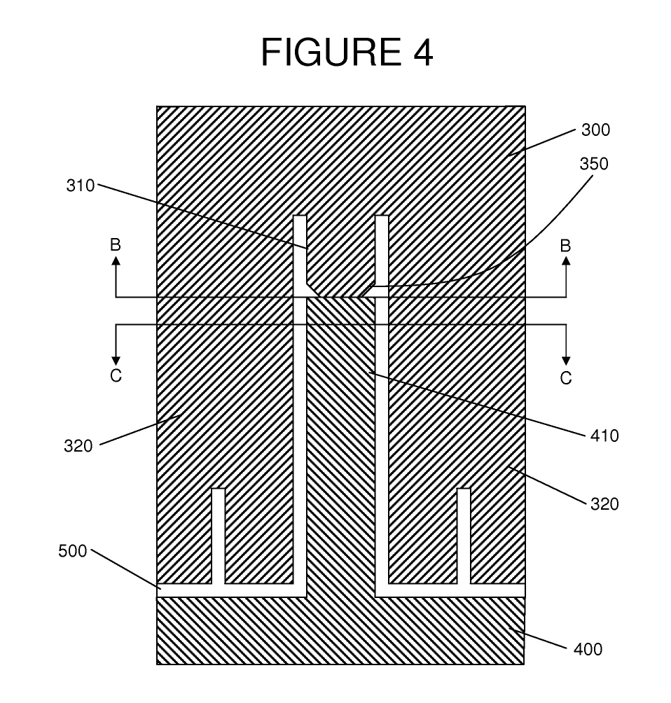

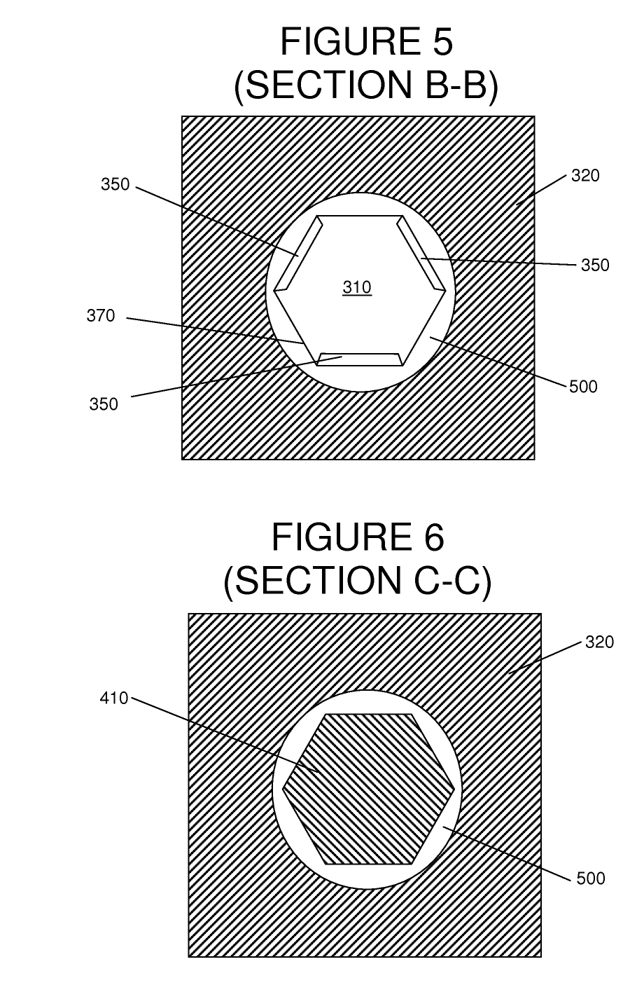

In accordance with another aspect of a particularly preferred embodiment of the invention, such anti-rotational and interlocking features are formed using a straight draw molding device and process. As shown in FIG. 4, a straight draw mold is used to form an interlock as described above, and preferably a non-rotational interlock as described above. A first mold member 300 is configured with a downwardly extending finger 310 and downwardly extending outer sidewall 320. A second mold member 400 is configured with a centrally located core member 410. A gap 500 is situated between first mold member 300 and second mold member 400 for molding the interlocking connection. Downwardly extending finger 310 has a contoured tip, narrowing at least in portions 350 of the tip to a width less than the width of core member 410. At such narrowed portion, and undercut will be formed on the interior surface of the device being molded. As shown in the bottom-up cross-sectional view of FIG. 5 along section line B-B of FIG. 4, the sidewall 320 of first mold member 300 forms a generally circular opening, thus preferably providing a generally cylindrical outer wall for hollow shaft 230. At its widest dimension, downwardly extending finger 310 has a generally non-circular, and preferably hexagonal, outer perimeter 370, and a plurality of tapered faces 350 having a slightly inward angle, thus tapering the outer perimeter of finger 310 along the length of tapered faces 350, while leaving the rest of the outer perimeter of finger 310 constant. Likewise, as shown in the top-down cross-sectional view of FIG. 6 along section line C-C of FIG. 4, core member 410 of second mold member 400 has a generally non-circular, and again preferably hexagonal, outer perimeter so as to provide the interior of hollow shaft 230 a generally constant, non-circular internal perimeter below the position of undercuts 232. During molding, when first mold member 300 is brought towards second mold member 400 so that contact is made between the bottom of downwardly extending finger 310 and the top of core member 400, tapered faces 350 will form undercuts 232 on a portion of the interior, non-circular walls of hollow shaft 230, which as discussed above, will prevent the separation of anchor 100 from base member 200 during installation.

Optionally, multiple downwardly extending fingers 310 may be provided in a single first mold member, and multiple core members 410 may be provided in a single second mold member, for simultaneously molding multiple interlocking connectors.

The invention has been described with references to a preferred embodiment. While specific values, relationships, materials, and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments shown and described will obviously occur to those skilled in the art upon becoming familiar with said underlying concept. It is intended to include all such modifications, alternatives and other embodiments in this invention. It should be understood, therefore, that the invention may be practiced otherwise than as specifically set forth herein. Consequently, the present embodiments are to be considered in all respects as illustrative and not restrictive.

1. An interlocking connector for joining elements of a multi-part system, comprising:
a base member comprising a base and a hollow shaft extending upwardly from said base, said hollow shaft having a non-circular interior perimeter and at least one undercut positioned on said non-circular interior perimeter; and
an anchor member comprising a support rod having a non-circular exterior perimeter configured for sliding engagement with said hollow shaft, a cap member at a first end of said anchor member configured for sliding engagement with said hollow shaft, and a region of reduced outer perimeter between said support rod and said cap member.

2. The interlocking connector of claim 1, said anchor member further comprising at least one arm attached to a second end of said anchor member opposite said first end and extending outward from said hollow shaft.

3. The interlocking connector of claim 2, further comprising a threaded connector positioned within said hollow shaft adjacent said second end of said anchor member.

4. The interlocking connector of claim 1, said support rod having a generally hexagonal outer perimeter.

5. The interlocking connector of claim 4, wherein said generally hexagonal outer perimeter further comprises a plurality of walls having a slightly concave face.

6. The interlocking connector of claim 1, said interior perimeter further comprising a hexagonal perimeter, and said undercut forming a ridge on at least one face of said hexagonal perimeter, said ridge reducing the interior perimeter of said hollow shaft along a length dimension of said ridge.

7. The interlocking connector of claim 6, wherein said ridge is positioned adjacent an end of said hollow shaft that is opposite said base.

8. The interlocking connector of claim 1, wherein said base member is formed through a straight draw molding process configured to form said undercut on said non-circular interior perimeter.

9. A wall anchor system having an interlocking connector configured to prevent the relative rotation of and the lateral separation of components of the wall anchor system, comprising:
a base member comprising a base, a hollow shaft extending upwardly from said base, and a support ring extending upwardly from said base and surrounding said hollow shaft, said hollow shaft having a non-circular interior perimeter and at least one undercut positioned on said non-circular interior perimeter; and
an anchor member comprising a support rod having a non-circular exterior perimeter configured for sliding engagement with said hollow shaft, a cap member at a first end of said anchor member configured for sliding engagement with said hollow shaft, and a region of reduced outer perimeter between said support rod and said cap member.

10. The interlocking connector of claim 9, said anchor member further comprising at least one arm attached to a second end of said anchor member opposite said first end and extending outward from said hollow shaft.

11. The interlocking connector of claim 10, further comprising a threaded connector positioned within said hollow shaft adjacent said second end of said anchor member.

12. The interlocking connector of claim 9, said support rod having a generally hexagonal outer perimeter.

13. The interlocking connector of claim 12, wherein said generally hexagonal outer perimeter further comprises a plurality of walls having a slightly concave face.

14. The interlocking connector of claim 9, said interior perimeter further comprising a hexagonal perimeter, and said undercut forming a ridge on at least one face of said hexagonal perimeter, said ridge reducing the interior perimeter of said hollow shaft along a length dimension of said ridge.

15. The interlocking connector of claim 14, wherein said ridge is positioned adjacent an end of said hollow shaft that is opposite said base.

16. The interlocking connector of claim 9, wherein said base member is formed through a straight draw molding process configured to form said undercut on said non-circular interior perimeter.
